(19) United States
(12) Patent Application Publication
(10) Pub. No.: US 2015/0185838 A1
(43) Pub. Date: Jul. 2, 2015

(54) WRIST BASED WEARABLE VIRTUAL KEYBOARD

(71) Applicants: Jose R. Camacho-Perez, Tlajomulco de Zuniga (MX); Hector A. Cordourier Maruri, Guadalajara (MX); Willem M. Beltman, West Linn, OR (US)

(72) Inventors: Jose R. Camacho-Perez, Tlajomulco de Zuniga (MX); Hector A. Cordourier Maruri, Guadalajara (MX); Willem M. Beltman, West Linn, OR (US)

(21) Appl. No.: 14/142,711

(22) Filed: Dec. 27, 2013

(51) Int. Cl. G06F 3/01; G06F 3/0488

(52) U.S. Cl. CPC G06F 3/014; G06F 3/04886

(57) ABSTRACT

In one example a control logic, at least partially including hardware logic, is configured to receive a first signal from at least one of the plurality of sensors, wherein the first signal represents first acceleration data associated with the at least one of the plurality of sensors over a predetermined time period, and in response to the first signal, to determine a symbol associated with the first acceleration data, and transmit a signal identifying the symbol to a remote electronic device. Other examples may be described.

### RELATED APPLICATIONS

None.

### BACKGROUND

The subject matter described herein relates generally to the field of electronic devices and more particularly to a wrist based virtual keyboard which may be used with electronic devices.

Many electronic devices such as tablet computers, mobile phones, electronic readers, computer-equipped glasses, etc., lack conventional keyboards. In some circumstances it may be useful to communicate with such electronic devices using an keyboard-like interface. Accordingly systems and techniques to provide for virtual keyboards may find utility.

### BRIEF DESCRIPTION OF THE DRAWINGS

The detailed description is described with reference to the accompanying figures.

FIG. 1A is a schematic illustration of wrist-based wearable virtual keyboard which may be adapted to work with electronic devices in accordance with some examples.

FIG. 1B is a schematic illustration of an architecture for a wrist-based wearable virtual keyboard which may be adapted to work with electronic devices in accordance with some examples.

FIG. 2 is a schematic illustration of components of an electronic device in accordance which may be adapted to work with a wrist-based wearable virtual keyboard in accordance with some examples.

FIGS. 3A-3C are schematic illustrations of gestures which may be used with a wrist-based wearable virtual keyboard in accordance with some examples.

FIG. 4 is a series of graphs illustrating response curves from sensors which may be used with a wrist-based wearable virtual keyboard in accordance with some examples.

FIG. 5 is a series of graphs illustrating mel-frequency cepstral coefficients of responses from sensors device which may be used with a wrist-based wearable virtual keyboard in accordance with some examples.

FIG. 6A is a schematic illustration of a finger-based keyboard mapping which may be used with a wrist-based wearable virtual keyboard in accordance with some examples.

FIG. 6B is a schematic illustration of a remote electronic device which may be used with a wrist-based wearable virtual keyboard in accordance with some examples.

FIGS. 7A-7B, 8A-8B, and 9A-9B are flowcharts illustrating operations in a method to use a wrist-based wearable virtual keyboard for electronic devices in accordance with some examples.

### DETAILED DESCRIPTION

Described herein are exemplary systems and methods to implement intelligent recording in electronic devices. In the following description, numerous specific details are set forth to provide a thorough understanding of various examples. However, it will be understood by those skilled in the art that the various examples may be practiced without the specific details. In other instances, well-known methods, procedures, components, and circuits have not been illustrated or described in detail so as not to obscure the particular examples.

Briefly, the subject matter described here addresses the concerns set forth above at least in part by wrist based wearable virtual keyboard which may be used with electronic devices. In some examples the wrist based wearable virtual keyboard may comprise a member which may be adapted to fit around a wrist of a user. The member may comprise a plurality of sensors disposed positioned to generate signals in response to parameters such as motion, orientation, or position of the user's hand and fingers. A controller is coupled to the sensors and includes logic to analyze the signals generated in response to movements of the users to associate a symbol with the signals. The symbol may be transmitted to one or more electronic devices, which may present the symbol on a display.

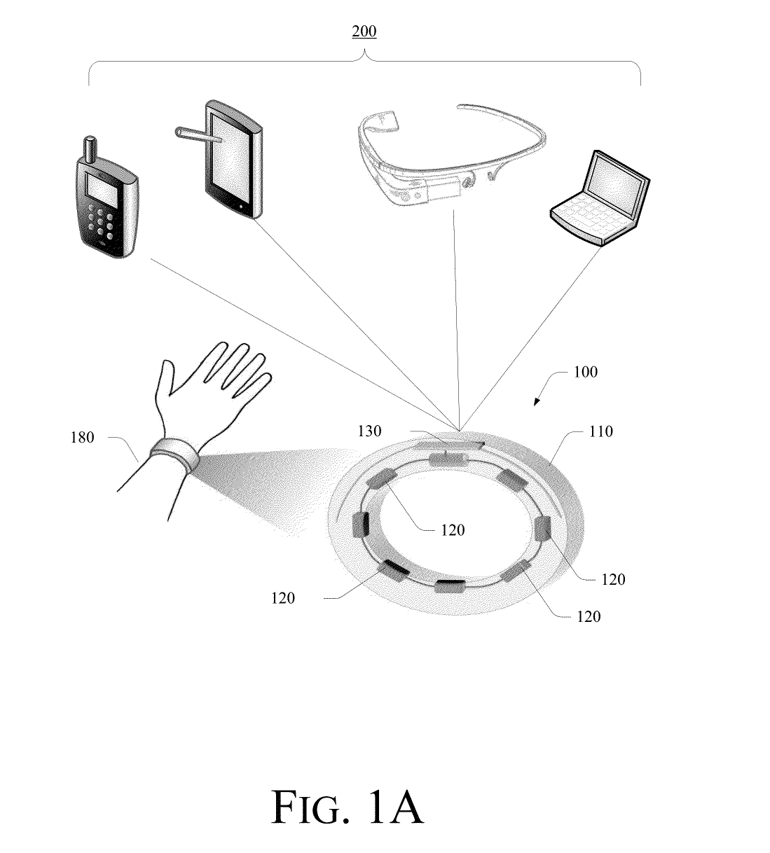

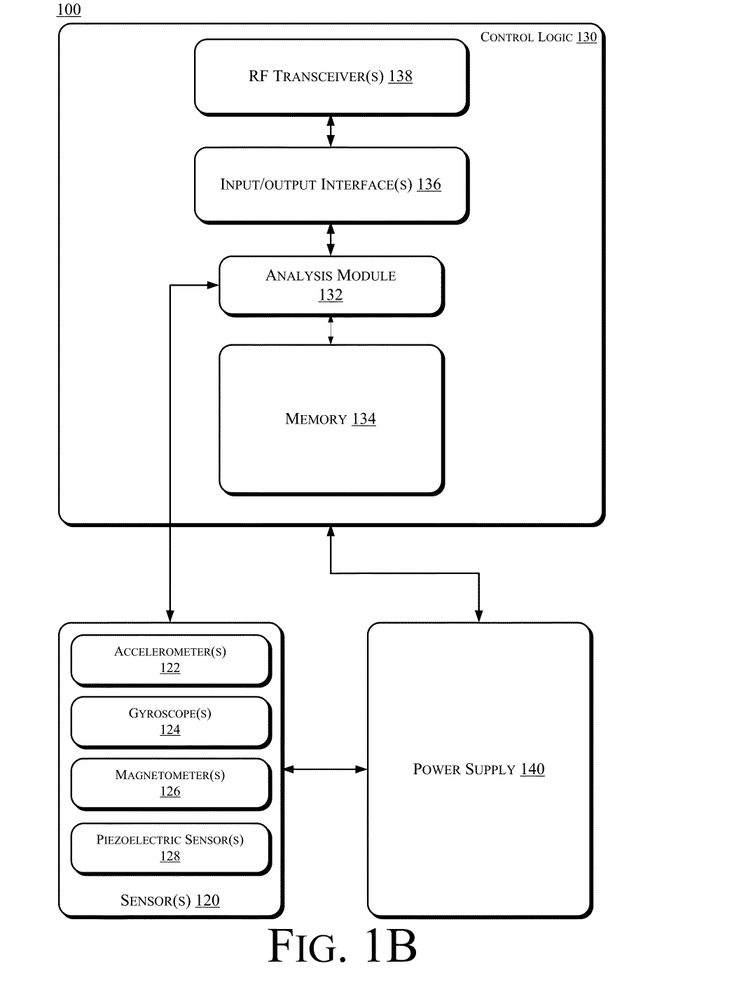

Specific features and details will be described with reference to FIGS. 1-9B, below.

FIG. 1A is a schematic illustration of wrist-based wearable virtual keyboard 100 which may be adapted to work with electronic devices in accordance with some examples, and FIG. 1B is a schematic illustration of an architecture for a wrist-based wearable virtual keyboard which may be adapted to work with electronic devices in accordance with some examples.

Referring to FIGS. 1A-1B, in some examples a wrist based virtual keyboard 100 may comprise a member 110 which and a plurality of sensors 120 disposed along the length of the member 110. The sensors 120 are communicatively coupled to a control logic 130 by a suitable communication link. Control logic 130 may be communicatively coupled to one or more remote electronic devices 200 by a suitable communication link.

For example, control logic 130 may be a controller, an application specific integrated circuit (ASIC), a general purpose processor, a graphics accelerator, an application processor, or the like.

For example, member 110 may be formed form any suitable rigid or flexible material such as a polymer, metal, cloth or the like. Member 110 may comprise an elastic or other material which allows the member 110 to fit snugly on a proximal side of a user's wrist, such that the sensors 120 are positioned proximate the wrist of a user.

Sensors 120 may comprise one or more sensors adapted to detect at least one of an acceleration, an orientation, or a position of the sensor, or combinations thereof. For example, sensors 120 may comprise one or more accelerometers 122, gyroscopes, 124, magnetometers 126, piezoelectric sensors 128, or the like.

Control logic 130 may be embodied as a general purpose processor, a network processor (that processes data communicated over a computer network 603), or other types of a processor (including a reduced instruction set computer (RISC) processor or a complex instruction set computer (CISC)). The specific implementation of control logic 130 is not critical.

Control logic 130 may comprise, or be coupled to, one or more input/output interfaces 136. In some examples input/output interface(s) may include, or be coupled to an RF transceiver 138 to transceive RF signals. RF transceiver may implement a local wireless connection via a protocol such as, e.g., Bluetooth or 802.11X. IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002) or other cellular type transceiver that can send/receive communication signals in accordance with various protocols, e.g., 2G, 3G, 4G, LTE, etc.

Control logic 130 may comprise, or be coupled to, a memory 134. Memory 134 may be implemented using volatile memory, e.g., static random access memory (SRAM), a dynamic random access memory (DRAM), nonvolatile memory, or non-volatile memory, e.g., phase change memory, NAND (flash) memory, ferroelectric random-access memory (FeRAM), nanowire-based non-volatile memory, memory that incorporates memristor technology, three dimensional (3D) cross point memory such as phase change memory (PCM), spin-transfer torque memory (STT-RAM) or NAND flash memory.

Control logic 130 further comprises an analysis module 132 to analyze signals generated by the sensors 120 and to determine a symbol associated with the signals. The signal may be transmitted to a remote electronic device 200 via the input/output interface 136. In some examples the analysis module may be implemented as logic instructions stored in non-transitory computer readable medium such as memory 134 and executable by the control logic 130. In other examples the analysis module 132 may be reduced to microcode or even to hard-wired circuitry on control logic 130.

A power supply 140 may be coupled to sensors 120 and control logic 130. For example, power supply 140 may comprise one or more energy storage devices, e.g., batteries or the like.

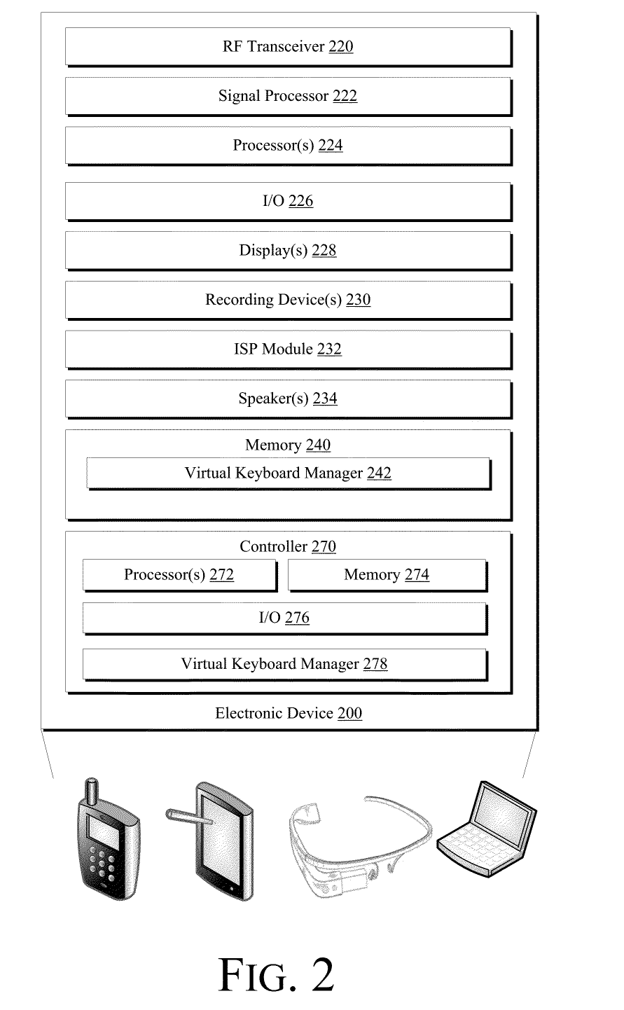

FIG. 2 is a schematic illustration of components of an electronic device in accordance which may be adapted to work with a wrist-based wearable virtual keyboard in accordance with some examples. In some aspects electronic device 200 may be embodied as a mobile telephone, a tablet computing device, a personal digital assistant (PDA), a notepad computer, a video camera, a wearable device like a smart watch, smart wrist band, smart headphone, or the like. The specific embodiment of electronic device 200 is not critical.

In some examples electronic device 200 may include an RF transceiver 220 to transceive RF signals and a signal processing module 222 to process signals received by RF transceiver 220. RF transceiver 220 may implement a local wireless connection via a protocol such as, e.g., Bluetooth or 802.11X. IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Electronic device 200 may further include one or more processors 224 and a memory module 240. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit. In some examples, processor 224 may be one or more processors in the family of Intel® PXA27x processors available from Intel® Corporation of Santa Clara, Calif. Alternatively, other processors may be used, such as Intel's Itanium®, XEON™, ATOM™, and Celeron® processors. Also, one or more processors from other manufactures may be utilized. Moreover, the processors may have a single or multi core design.

In some examples, memory module 240 includes random access memory (RAM); however, memory module 240 may be implemented using other memory types such as dynamic RAM (DRAM), synchronous DRAM (SDRAM), and the like. Memory 240 may comprise one or more applications including a recording manager 242 which execute on the processor(s) 222.

Electronic device 200 may further include one or more input/output interfaces such as, e.g., a keypad 226 and one or more displays 228, speakers 234, and one or more recording devices 230. By way of example, recording device(s) 230 may comprise one or more cameras and/or microphones An image signal processor 232 may be provided to process images collected by recording device(s) 230.

In some examples electronic device 200 may include a low-power controller 270 which may be separate from processor(s) 224, described above. In the example depicted in FIG. 2 the controller 270 comprises one or more processor(s) 272, a memory module 274, an I/O module 276, and a recording manager 278. In some examples the memory module 274 may comprise a persistent flash memory module and the authentication module 276 may be implemented as logic instructions encoded in the persistent memory module, e.g., firmware or software. The I/O module 276 may comprise a serial I/O module or a parallel I/O module. Again, because the adjunct controller 270 is physically separate from the main processor(s) 224, the controller 270 can operate independently while the processor(s) 224 remains in a low-power consumption state, e.g., a sleep state. Further, the low-power controller 270 may be secure in the sense that the low-power controller 270 is inaccessible to hacking through the operating system.

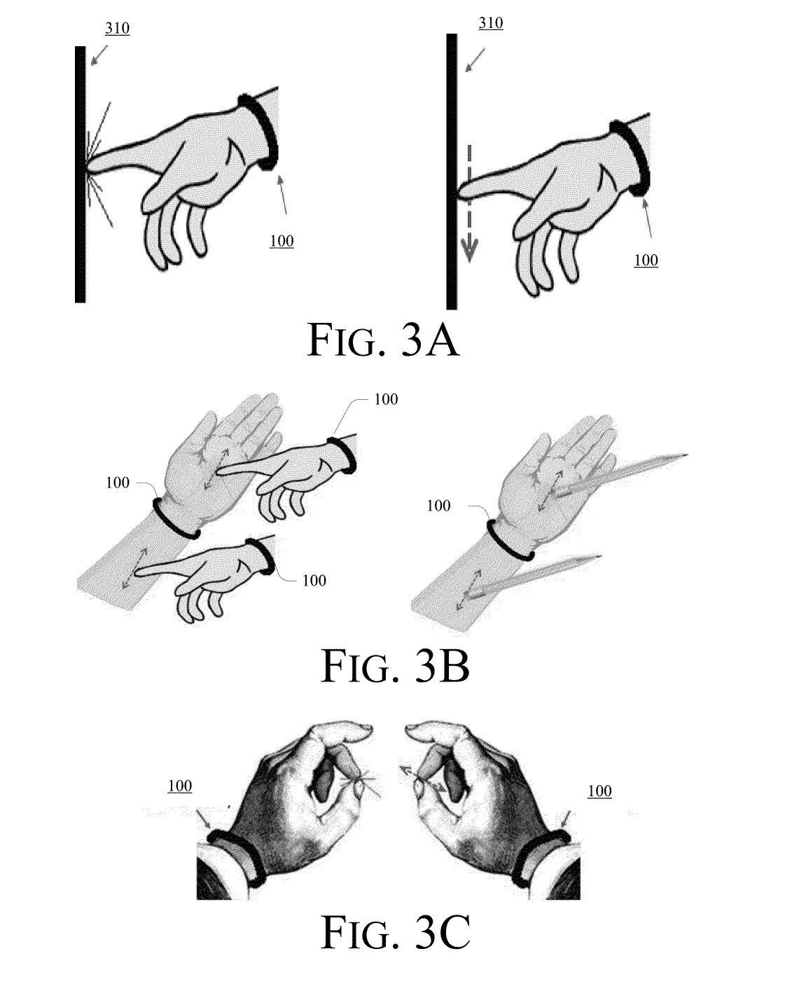

As described briefly above, a wrist based wearable virtual keyboard 100 may be disposed about a user's wrist and used to detect motion, position, and orientation, or combinations thereof. FIGS. 3A-3C are schematic illustrations of gestures which may be used with a wrist based wearable virtual keyboard in accordance with some examples. For example, a wrist based wearable virtual keyboard 100 may be used to detect a finger tap on a surface 310 or a finger slide on a surface 310, as illustrated in FIG. 3A. Alternatively, or in addition, a wrist based wearable virtual keyboard 100 may be used to detect contact with a hand or arm of the user proximate the wrist based wearable virtual keyboard 100, as illustrated in FIG. 3B. Alternatively, or in addition, the wrist based wearable virtual keyboard 100 may be used to detect particular patterns of contact with the fingers of a user, as illustrated in FIG. 3C.

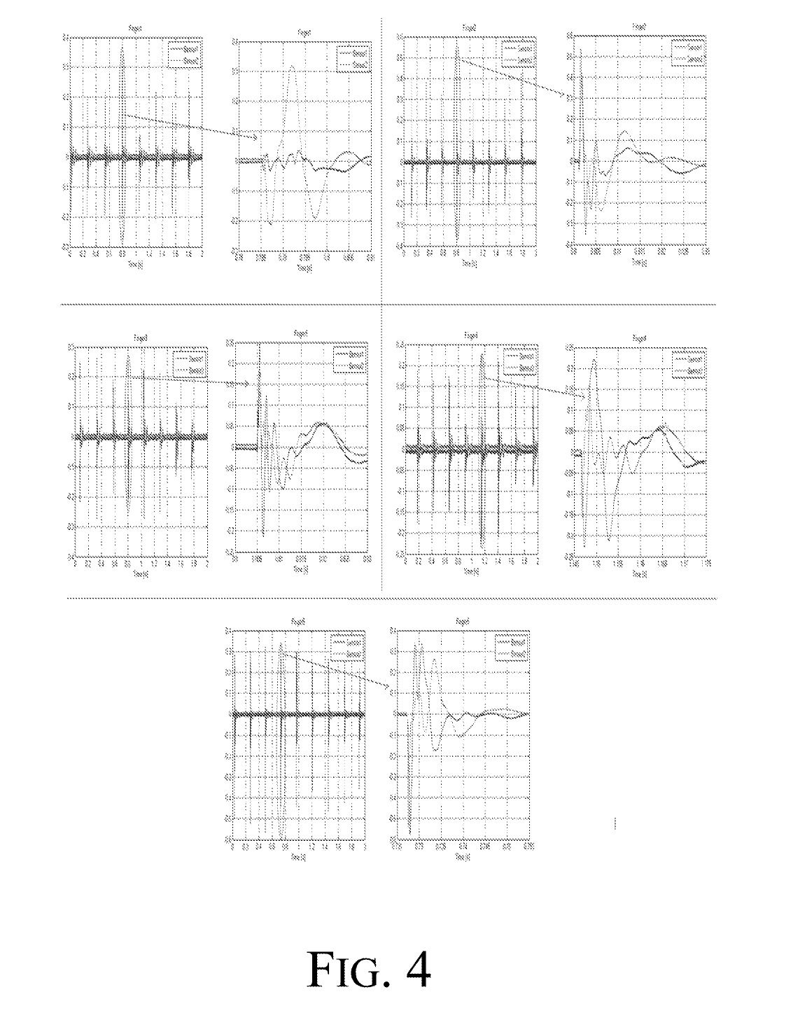

The sensors 120 generate characteristic response curves in response to the various types of contact depicted in FIGS. 3A-3C. For example, FIG. 4 is a series of graphs illustrating response curves from sensors 120 which may be used with a wrist-based wearable virtual keyboard in accordance with some examples. The curves denote the output from specific sensors made in response to specific movements by specific fingers of a user. In operation, data from the response curves may be stored in memory, e.g., memory 134, to construct a profile of response curves for a user of a wrist based wearable virtual keyboard 100.

Similarly, FIG. 5 is a series of graphs illustrating mel-frequency cepstral coefficients of responses from sensors device which may be used with a wrist-based wearable virtual keyboard 100 in accordance with some examples. Referring to FIG. 5, acceleration/vibration data from a dragging or a rubbing motion such as when a user rubs a finger against a surface or rubs an object against a hand or arm may be processed by analysis module 132 to generate mel-frequency cepstral coefficients (MFCCs) associated with the dragging motion. Data characterizing the mel-frequency cepstral coefficients may be stored in memory, e.g., memory 134 to construct a profile of response curves for a user of a wrist based wearable virtual keyboard 100.

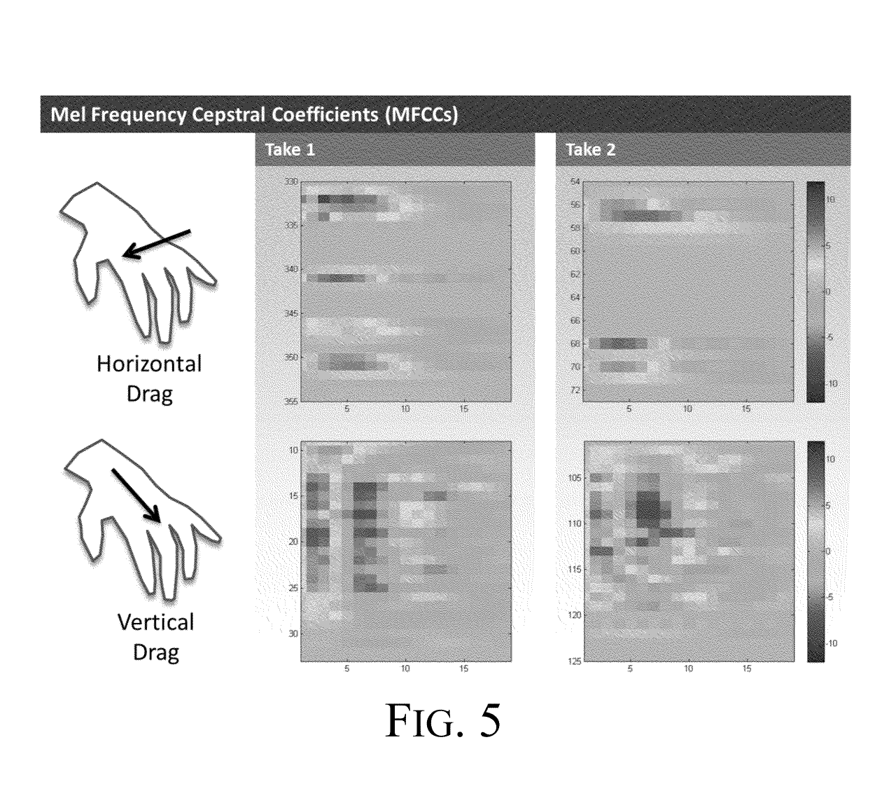

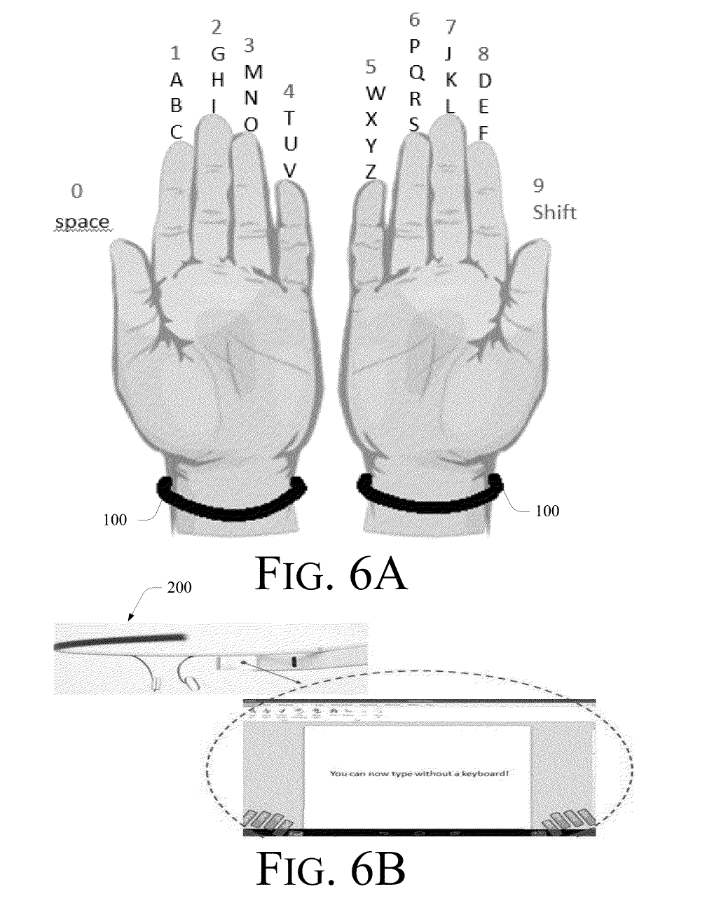

With data representing the various sensor responses to different hand motions, positions, and orientations stored in memory a virtual keyboard mapping may be generated. FIG. 6A is a schematic illustration of a finger-based keyboard mapping which may be used with a wrist-based wearable virtual keyboard in accordance with some examples.

Referring to FIG. 6A, in some examples a set of symbols may be assigned to each finger. A symbol may be selected by tapping or scratching each finger a predetermined number of times. Additional symbols or functions may be mapped to alternative hand gestures, e.g., specific motions or orientations of a user's hand.

FIG. 6B is a schematic illustration of a remote electronic device which may be used with a wrist-based wearable virtual keyboard in accordance with some examples. As illustrated in FIG. 6B, in some examples the symbol assignment may be presented on a display of an electronic device 200.

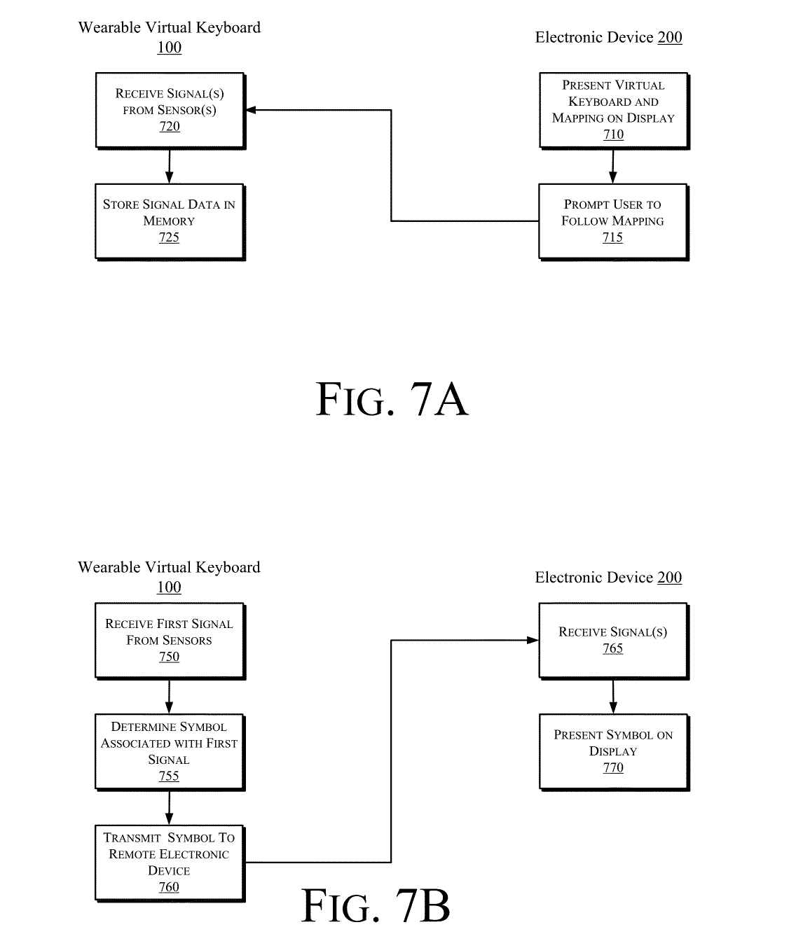

Having described various structures to implement intelligent recording in electronic devices, operating aspects will be explained with reference to FIGS. 7A-7B, 8A-8B, and 9A-9B, which are flowcharts illustrating operations in a method to use a wrist-based wearable virtual keyboard for electronic devices in accordance with some examples. Some operations depicted in the flowchart of FIGS. 7A-7B, 8A-8B, and 9A-9B may be implemented by the analysis module 132.

In some examples a user may be prompted to execute a series of training exercises for the wearable virtual keyboard 100. The training exercises may be designed to obtain measurements from sensors 120 when the user implements hand motions corresponding to various symbols. One example of a training methodology is depicted in FIG. 7A. Referring to FIG. 7A, at operation 710 the virtual keyboard manager 242/278 in electronic device 200 presents a virtual keyboard and a symbol mapping on a display 228 of electronic device 200.

At operation 715 the virtual keyboard manager 242/278 prompts a user to follow the mapping of the virtual keyboard. By way of example, virtual keyboard manager 242/278 may present a series of graphics on the display 228 of electronic device prompting a user to implement gestures (e.g., finger taps, drags, hand rotations, etc.) which correspond to a symbol.

At operation 720 the control logic 130 of wearable virtual keyboard 100 receives signals from the sensors 120 in response to the gesture implemented by the user. The control logic 130 may sample the responses from all of the sensors 120 or only from a subset of the sensors 120. For example, the control logic may sample only the sensors closest to a finger that is being tapped or otherwise used in a training exercise. In some examples the data may comprise acceleration, either from movement of a finger or arm, or from movement of skin, e.g., a vibration, response curves of the type depicted in FIG. 4. In other examples the data my comprise orientation data which may be stored alone or in combination with the acceleration data. In further examples the acceleration data may be processed to determine one or more characteristics such as a mel-frequency cepstral coefficient of the acceleration data.

At operation 725 signal data from the sensor(s) 120 and associated data stored in memory 134. In some examples the data may be stored in association with the symbol that was presented on the display 228 of the electronic device 200.

The operations depicted in FIG. 7A may be repeated to complete a mapping between hand movements and symbols representative of a conventional QWERTY keyboard. Additional keyboard functions (e.g., backspace, delete, escape, etc.) may be mapped to specific movements or gestures. The mapping may be stored in memory 134.

With the mapping stored in memory 134 the virtual wearable keyboard 100 may be used as an input/output device with an electronic device 200. Referring to FIG. 7B, at operation 750 the control logic 130 in wearable virtual keyboard 100 receives a first signal from sensors 120. By way of example, a user may implement a movement associated with a symbol as defined in the training process depicted in FIG. 7A, e.g., a finger tap, double tap, triple tap, a finger drag, a hand rotation, or the like.

At operation 755 the analysis module 132 determines a symbol associated with the first signal received in operation 750, and at operation 760 the analysis module 132 transmits one or more signals which comprises the symbol associated with the signal received in operation 750 to the electronic device 200. At operation 765 the electronic device 200 receives the signal(s) and at operation 770 the electronic device presents the symbol on the display 228.

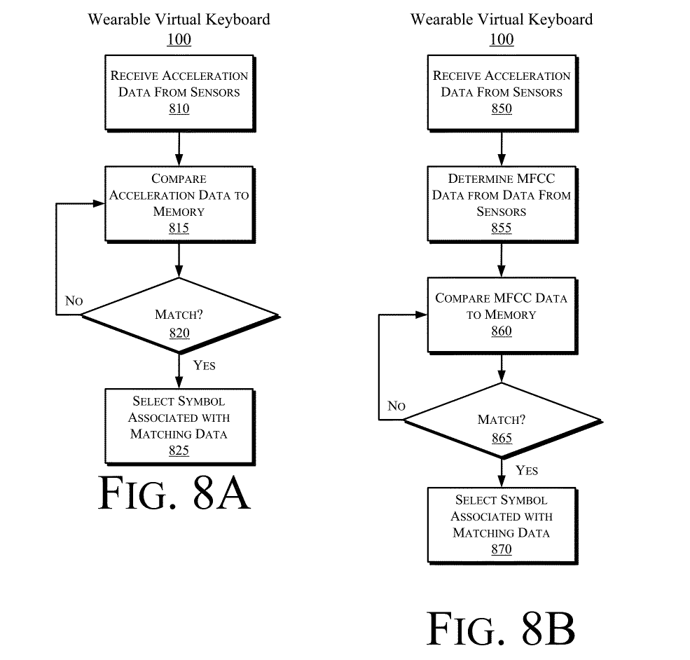

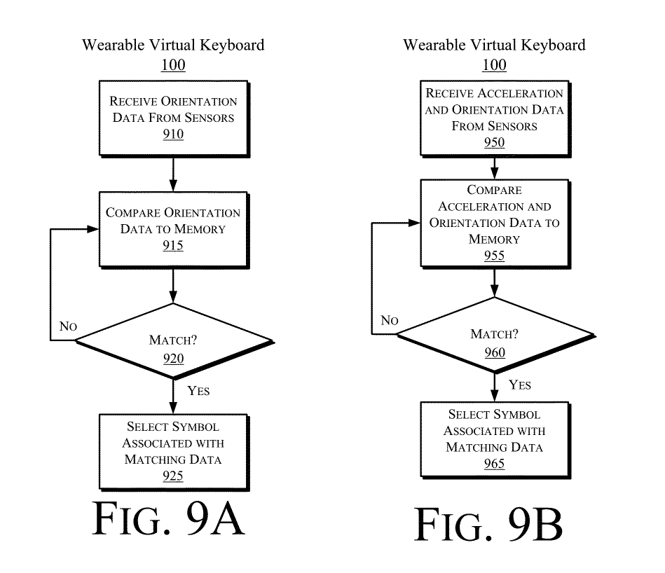

The analysis module 132 may use a number of different techniques to make the determination depicted in operation 755. FIGS. 8A-8B and 9A-9B depict operations associated with various techniques. In one example the analysis module matches acceleration data received from sensors 120 with acceleration data stored in memory 134 to select a symbol. Referring first to FIG. 8A, at operation 810 the control logic 130 in wearable virtual keyboard 100 receives acceleration data from sensors 120. At operation 815 the analysis module 132 compares the acceleration data to acceleration data stored in memory 134. If, at operation 820, a data record selected in memory does not match the acceleration data received from sensors 120 then control passes back to operation 815 and another data record is selected for comparison.

By contrast, if at operation 820 there is a match between the data record selected in memory and the acceleration data received from sensors 120 then control passes to operation 825 and the analysis module 132 selects the symbol associated with the matching data.

In another example the analysis module matches mel-frequency cepstral coefficient data derived from acceleration data received from sensors 120 with mel-frequency cepstral coefficient data stored in memory 134 to select a symbol. Referring to FIG. 8B, at operation 850 the control logic 130 in wearable virtual keyboard 100 receives acceleration data from sensors 120. At operation 855 the analysis module determines mel-frequency cepstral coefficient data from the acceleration data received from the sensors 120. At operation 860 the analysis module 132 compares the mel-frequency cepstral coefficient data to mel-frequency cepstral coefficient data stored in memory 134. If, at operation 865, a data record selected in memory does not match the mel-frequency cepstral coefficient data determined from acceleration data received from sensors 120 then control passes back to operation 860 and another data record is selected for comparison.

By contrast, if at operation 865 there is a match between the data record selected in memory and the mel-frequency cepstral coefficient determined from the acceleration data received from sensors 120 then control passes to operation 870 and the analysis module 132 selects the symbol associated with the matching data.

In another example the analysis module 132 matches orientation data derived from acceleration data received from sensors 120 with orientation data stored in memory 134 to select a symbol. Referring to FIG. 9A, at operation 910 the control logic 130 in wearable virtual keyboard 100 receives orientation data from sensors 120. At operation 915 the analysis module 132 compares orientation data to orientation data stored in memory 134. If, at operation 920, orientation data associated with a data record selected in memory does not match orientation data determined from orientation data received from sensors 120 then control passes back to operation 860 and another data record is selected for comparison.

By contrast, if at operation 865 there is a match between the orientation data in the data record selected in memory and the orientation data received from sensors 120 then control passes to operation 870 and the analysis module 132 selects the symbol associated with the matching data.

In another example the analysis module 132 matches combined acceleration and orientation data derived from acceleration data received from sensors 120 with combined acceleration and orientation data stored in memory 134 to select a symbol. Referring to FIG. 9A, at operation 950 the control logic 130 in wearable virtual keyboard 100 receives combined acceleration and orientation data from sensors 120. At operation 955 the analysis module 132 compares combined acceleration and orientation data to orientation data stored in memory 134. If, at operation 960, combined acceleration and orientation data associated with a data record selected in memory does not match combined acceleration and orientation data determined from orientation data received from sensors 120 then control passes back to operation 955 and another data record is selected for comparison.

By contrast, if at operation 960 there is a match between the orientation data in the data record selected in memory and the orientation data received from sensors 120 then control passes to operation 965 and the analysis module 132 selects the symbol associated with the matching data.

Thus, the operations depicted in FIGS. 7A-7B, 8A-8B, and 9A-9B enable the a wearable virtual keyboard 100 to function as an input/output device for an electronic device 200. In examples in which the sensors 120 comprise piezoelectric devices the sensors 120 may provide a user with tactile feedback, e.g., by vibrating, in response to one or more conditions. For example, a piezoelectric sensor 128 may vibrate when a user correctly enters a motion to generate a symbol.

The following examples pertain to further examples.

Example 1 is a controller comprising logic, at least partially including hardware logic, configured to receive a first signal from at least one of the plurality of sensors, wherein the first signal represents first acceleration data associated with the at least one of the plurality of sensors over a predetermined time period, and in response to the first signal, to determine a symbol associated with the first acceleration data and transmit a signal identifying the symbol to a remote electronic device

In Example 2, the subject matter of Example 1 can optionally include an arrangement in which the plurality of sensors are coupled to a member adapted to fit on a proximal side of a wrist of a user.

In Example 3, the subject matter of any one of Examples 1-2 can optionally include logic further configured to compare the first acceleration data to acceleration data stored in memory.

In Example 4, the subject matter of any one of Examples 1-3 can optionally include logic further configured to determine a mel-frequency cepstral coefficient associated with the first acceleration data, determine a symbol associated with the mel-frequency cepstral coefficient, and transmit a signal identifying the symbol to a remote electronic device.

In Example 5, the subject matter of any one of Examples 1-4 can optionally include logic further configured to compare the mel-frequency cepstral coefficient associated with the first acceleration data to a mel-frequency cepstral coefficient stored in memory.

In Example 6, the subject matter of any one of Examples 1-5 can optionally include logic further configured to receive a second signal from at least one of the plurality of sensors, wherein the second signal represents first orientation data associated with the at least one of the plurality of sensors over a predetermined time period, and in response to the second signal, to determine a symbol associated with the first orientation data, and transmit a signal identifying the symbol to a remote electronic device.

In Example 7, the subject matter of any one of Examples 1-6 can optionally include logic further configured to determine a symbol associated a combination of the first orientation data and the first acceleration data, and transmit a signal identifying the symbol to a remote electronic device.

In Example 8, the subject matter of any one of Examples 1-7 can optionally include logic further configured to compare the combination of the first orientation data and the first acceleration data to a combination of the first orientation data and the first acceleration data stored in memory.

Example 9 is an apparatus, comprising a member, a plurality of sensors disposed along the member, a control logic comprising logic, at least partially including hardware logic, configured to receive a first signal from at least one of the plurality of sensors, wherein the first signal represents first acceleration data associated with the at least one of the plurality of sensors over a predetermined time period, and in response to the first signal, to determine a symbol associated with the first acceleration data, and transmit a signal identifying the symbol to a remote electronic device.

In Example 10, the subject matter of Example 9 can optionally include an arrangement in which the plurality of sensors are coupled to a member adapted to fit on a proximal side of a wrist of a user.

In Example 11, the subject matter of any one of Examples 9-10 can optionally include logic further configured to compare the first acceleration data to acceleration data stored in memory.

In Example 12, the subject matter of any one of Examples 9-12 can optionally include logic further configured to determine a mel-frequency cepstral coefficient associated with the first acceleration data, determine a symbol associated with the mel-frequency cepstral coefficient, and transmit a signal identifying the symbol to a remote electronic device.

In Example 13, the subject matter of any one of Examples 9-12 can optionally include logic further configured to compare the mel-frequency cepstral coefficient associated with the first acceleration data to a mel-frequency cepstral coefficient stored in memory.

In Example 14, the subject matter of any one of Examples 9-13 can optionally include logic further configured to receive a second signal from at least one of the plurality of sensors, wherein the second signal represents first orientation data associated with the at least one of the plurality of sensors over a predetermined time period, and in response to the second signal, to determine a symbol associated with the first orientation data, and transmit a signal identifying the symbol to a remote electronic device.

In Example 15, the subject matter of any one of Examples 9-15 can optionally include logic further configured to determine a symbol associated a combination of the first orientation data and the first acceleration data, and transmit a signal identifying the symbol to a remote electronic device.

In Example 16, the subject matter of any one of Examples 9-16 can optionally include logic further configured to compare the combination of the first orientation data and the first acceleration data to a combination of the first orientation data and the first acceleration data stored in memory.

Example 17 is a computer program product comprising logic instructions stored on a non-transitory computer readable medium which, when executed by a control logic, configure the control logic to receive a first signal from at least one of the plurality of sensors, wherein the first signal represents first acceleration data associated with the at least one of the plurality of sensors over a predetermined time period, and in response to the first signal, to determine a symbol associated with the first acceleration data, and transmit a signal identifying the symbol to a remote electronic device.

In Example 18, the subject matter of Example 17 can optionally include an arrangement in which the plurality of sensors are coupled to a member adapted to fit on a proximal side of a wrist of a user.

In Example 19, the subject matter of any one of Examples 17-18 can optionally include logic further configured to compare the first acceleration data to acceleration data stored in memory.

In Example 20, the subject matter of any one of Examples 17-19 can optionally include logic further configured to determine a mel-frequency cepstral coefficient associated with the first acceleration data, determine a symbol associated with the mel-frequency cepstral coefficient, and transmit a signal identifying the symbol to a remote electronic device.

In Example 21, the subject matter of any one of Examples 17-20 can optionally include logic further configured to compare the mel-frequency cepstral coefficient associated with the first acceleration data to a mel-frequency cepstral coefficient stored in memory.

In Example 22, the subject matter of any one of Examples 17-21 can optionally include logic further configured to receive a second signal from at least one of the plurality of sensors, wherein the second signal represents first orientation data associated with the at least one of the plurality of sensors over a predetermined time period, and in response to the second signal, to determine a symbol associated with the first orientation data, and transmit a signal identifying the symbol to a remote electronic device.

In Example 23, the subject matter of any one of Examples 17-22 can optionally include logic further configured to determine a symbol associated a combination of the first orientation data and the first acceleration data, and transmit a signal identifying the symbol to a remote electronic device.

In Example 24, the subject matter of any one of Examples 17-23 can optionally include logic further configured to compare the combination of the first orientation data and the first acceleration data to a combination of the first orientation data and the first acceleration data stored in memory.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and examples are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and examples are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and examples are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular examples, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one example” or “some examples” means that a particular feature, structure, or characteristic described in connection with the example is included in at least an implementation. The appearances of the phrase “in one example” in various places in the specification may or may not be all referring to the same example.

Although examples have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A control logic, at least partially including hardware logic, configured to:
receive a first signal from at least one of the plurality of sensors, wherein the first signal represents first acceleration data associated with the at least one of the plurality of sensors over a predetermined time period; and
in response to the first signal, to:
determine a symbol associated with the first acceleration data; and
transmit a signal identifying the symbol to a remote electronic device.

2. The control logic of claim 1, wherein the plurality of sensors are coupled to a member adapted to fit on a proximal side of a wrist of a user.

3. The control logic of claim 1, wherein the logic to determine a symbol associated with the first acceleration data comprises logic to:
compare the first acceleration data to acceleration data stored in memory.

4. The control logic of claim 1, wherein the control logic comprises logic, at least partially including hardware logic, configured to:
determine a mel-frequency cepstral coefficient associated with the first acceleration data;
determine a symbol associated with the mel-frequency cepstral coefficient; and
transmit a signal identifying the symbol to a remote electronic device.

5. The control logic of claim 4, wherein the logic to determine a symbol associated with the first acceleration data comprises logic to:
compare the mel-frequency cepstral coefficient associated with the first acceleration data to a mel-frequency cepstral coefficient stored in memory.

6. The control logic of claim 1, wherein the control logic comprises logic, at least partially including hardware logic, to:
receive a second signal from at least one of the plurality of sensors, wherein the second signal represents first orientation data associated with the at least one of the plurality of sensors over a predetermined time period; and
in response to the second signal, to:
determine a symbol associated with the first orientation data; and
transmit a signal identifying the symbol to a remote electronic device.

7. The control logic of claim 6, further comprising logic, at least partially including hardware logic, to:
determine a symbol associated a combination of the first orientation data and the first acceleration data; and
transmit a signal identifying the symbol to a remote electronic device.

8. The control logic of claim 1, wherein the logic to determine a symbol associated with the first acceleration data comprises logic to:
compare the combination of the first orientation data and the first acceleration data to a combination of the first orientation data and the first acceleration data stored in memory.

9. An apparatus, comprising:
a member;
a plurality of sensors disposed along the member;
a control logic comprising logic, at least partially including hardware logic, configured to:
receive a first signal from at least one of the plurality of sensors, wherein the first signal represents first acceleration data associated with the at least one of the plurality of sensors over a predetermined time period; and
in response to the first signal, to:
determine a symbol associated with the first acceleration data; and
transmit a signal identifying the symbol to a remote electronic device.

10. The apparatus of claim 9, wherein the flexible member is adapted to fit on a proximal side of a wrist of a user.

11. The apparatus of claim 9, wherein the logic to determine a symbol associated with the first acceleration data comprises logic to:
compare the first acceleration data to acceleration data stored in memory.

12. The apparatus of claim 9, wherein the control logic comprises logic, at least partially including hardware logic, configured to:
determine a mel-frequency cepstral coefficient associated with the first acceleration data;
determine a symbol associated with the mel-frequency cepstral coefficient; and
transmit a signal identifying the symbol to a remote electronic device.

13. The apparatus of claim 9, wherein the logic to determine a symbol associated with the first acceleration data comprises logic to:
compare the mel-frequency cepstral coefficient associated with the first acceleration data to a mel-frequency cepstral coefficient stored in memory.

14. The apparatus of claim 13, wherein the control logic further comprises logic, at least partially including hardware logic, to:
receive a second signal from at least one of the plurality of sensors, wherein the second signal represents first orientation data associated with the at least one of the plurality of sensors over a predetermined time period; and
in response to the second signal, to:
determine a symbol associated with the first orientation data; and
transmit a signal identifying the symbol to a remote electronic device.

15. The apparatus of claim 9, further comprising logic, at least partially including hardware logic, to:
determine a symbol associated a combination of the first orientation data and the first acceleration data; and
transmit a signal identifying the symbol to a remote electronic device.

16. The apparatus of claim 9, wherein the control logic further comprises logic, at least partially including hardware logic, to:
determine a symbol associated a combination of the first orientation data and the first acceleration data; and
transmit a signal identifying the symbol to a remote electronic device.

17. A computer program product comprising logic instructions stored on a non-transitory computer readable medium which, when executed by a control logic, configure the control logic to:
receive a first signal from at least one of the plurality of sensors, wherein the first signal represents first acceleration data associated with the at least one of the plurality of sensors over a predetermined time period; and
in response to the first signal, to:
determine a symbol associated with the first acceleration data; and
transmit a signal identifying the symbol to a remote electronic device.

18. The computer program product of claim 17, wherein the plurality of sensors are coupled to a member adapted to fit on a proximal side of a wrist of a user.

19. The computer program product of claim 17, wherein the logic to determine a symbol associated with the first acceleration data comprises logic to:
compare the first acceleration data to acceleration data stored in memory.

20. The computer program product of claim 17, comprising logic instructions stored on a tangible computer readable medium which, when executed by the control logic, configure the control logic to:
determine a mel-frequency cepstral coefficient associated with the first acceleration data;
determine a symbol associated with the mel-frequency cepstral coefficient; and
transmit a signal identifying the symbol to a remote electronic device.

21. The computer program product of claim 17, wherein the logic to determine a symbol associated with the first acceleration data comprises logic to:
compare the mel-frequency cepstral coefficient associated with the first acceleration data to a mel-frequency cepstral coefficient stored in memory.

22. The computer program product of claim 17, comprising logic instructions stored on a tangible computer readable medium which, when executed by the control logic, configure the control logic to:
receive a second signal from at least one of the plurality of sensors, wherein the second signal represents first orientation data associated with the at least one of the plurality of sensors over a predetermined time period; and
in response to the second signal, to:
determine a symbol associated with the first orientation data; and
transmit a signal identifying the symbol to a remote electronic device.

23. The computer program product of claim 22, further comprising logic, at least partially including hardware logic, to:
determine a symbol associated a combination of the first orientation data and the first acceleration data; and
transmit a signal identifying the symbol to a remote electronic device.

24. The computer program product of claim 17, comprising logic instructions stored on a tangible computer readable medium which, when executed by the control logic, configure the control logic to:
determine a symbol associated a combination of the first orientation data and the first acceleration data; and
transmit a signal identifying the symbol to a remote electronic device.
